(19) United States
(12) Patent Application Publication
(10) Pub. No.: US 2003/0185532 A1
(43) Pub. Date: Oct. 2, 2003

(54) Optical functional device and fabrication process for the same

(76) Inventors: Kazuhiko Hosomi, Tachikawa (JP); Toshio Katsuyama, Ome (JP); Youngkun Lee, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/320,467

(22) Filed: Dec. 17, 2002

(30) Foreign Application Priority Data
Mar. 29, 2002 (JP) 2002-094047

(51) Int. Cl. G02B 6/10; G02B 6/26

(52) U.S. Cl. 385/129; 385/125; 385/15

(57) ABSTRACT

A photonic crystal has a relatively simple configuration and exhibits a sufficiently large refractive index change. An optical functional device uses the photonic crystal, and a process fabricates such an optical functional device. The photonic crystal includes at least one polymer as a material and changes in refractive index by changing the temperature of the polymer to thereby control the band structure of the photonic crystal. For example, a polymer is charged into holes arranged in a two-dimensional photonic crystal and is heated using a thin-film heater or is cooled using a Peltier device. The temperature is controlled by a temperature controller.

### BACKGROUND OF THE INVENTION

1. Field of the Invention

The present invention relates to optical functional devices that can be used as, for example, dispersion compensators, optical switches, wavelength filters, and optical time-delay devices.

2. Description of the Related Art

Photonic crystals have become a big concern as a material that can control light. In contrast, conventional devices cannot control the light. The photonic crystals have a multidimensional structure comprising two or more different materials.

FIG. 2 shows a “two-dimensional photonic crystal”. The two-dimensional photonic crystal is structurally periodic in a horizontal direction and is uniform in a perpendicular direction with respect to the paper plane. The two-dimensional photonic crystal comprises columns having a dielectric constant of ε₂ arrayed in the form of triangular lattice in a medium having a dielectric constant of ε₁, wherein ε₁>ε₂. When the columns are the air, ε₂ is 1. In FIG. 2, the triangular lattice has a lattice constant of “a” and a radius of column of “r”.

FIG. 3 is a photonic band diagram showing the relation between the wave number and the frequency of light transmitting the photonic crystal of FIG. 2 in a transverse magnetic mode (TM mode), in which ε₁ is 3.5, ε₂ is 1, and r/a is 0.45. The TM mode used herein means a mode in which an electric field is perpendicular to the paper plane. In FIG. 3, the ordinate shows the normalized frequency (ωa/2πc) and the abscissa shows the wavevector (ka/2π) normalized in a first Brillouin zone, wherein c is the velocity of light in vacuo; ω is the angular frequency of light; and k is the wave number. The triangular lattice shown in FIG. 2 corresponds to the six-fold symmetry, and the resulting Brillouin zone is structurally an equilateral hexagon shown in FIG. 3. The equilateral hexagon has a vertex K, a midpoint M, and a point Γ where the wave number is zero.

No band is present in the entire first Brillouin zone at specific (normalized) frequencies as shown as the diagonally shaded area in FIG. 3. This means that light having a frequency corresponding to this band cannot transmit or propagate in the photonic crystal. Such a frequency band in which transmission is forbidden is referred to as “photonic band gap”. By using the photonic band gap, the device enables the light control which cannot be achieved by conventional devices. The light transmitting the photonic crystal shows specific complex dispersion properties as shown in FIG. 3, in addition to the band gap.

Investigations have been intensively made on the photonic crystals having the above features to apply them various fields, especially to optical parts. It is believed that when waveguides and other optical functional devices are fabricated by introducing a line/point defect into a two-dimensional photonic crystal, the resulting optical functional devices can be miniaturized and have high performance. Accordingly, a variety of devices have been proposed and studied.

For example, Japanese Patent Application Laid-Open No. 11-271541 discloses a wavelength filter circuit using a photonic crystal. In this device, a two-dimensional photonic crystal is formed on a substrate, multiplexed light pulses are filtered or branched using an anisotropic refractive index dispersion.

Japanese Patent Application Laid-Open No. 2000-121987 discloses a wavelength dispersion compensator, in which the deterioration of pulse waveform in an optical transmission path is compensated using the characteristics of the photonic crystal. The publication mentions that a compact dispersion compensator can be provided by utilizing an area having a large slope of the wavelength dispersion, i.e., an area having a large wavelength dispersion, in a complicated dispersion curve as shown in FIG. 3.

Certain “coupled cavity waveguides” receive attention, in which point defects are formed in a photonic crystal to yield microcavities, and plural microcavities are arrayed at regular intervals to form a waveguide. The features of the coupled microcavities are described in, for example, Optics Letters 24, 711-713 (1999). In this type of waveguides, the group velocity of transmitting light significantly varies depending on the wavelength and has a small absolute value. The device is thus promising in the application to dispersion compensators and time-delayed circuits.

Optical switches, optical amplitude modulators and other optical functional devices control light transmission by changing the refractive index, reflectivity, and other physical material constants by, for example, the application of an external voltage.

Likewise, to impart functions to devices using a photonic crystal, the physical material constants must be externally controlled. Such physical material constants to determine the properties of the photonic crystal are the refractive index (difference) of the materials and the lattice constant of the primary structure, but, in general, the lattice constant cannot significantly be controlled. Accordingly, controlling the refractive indices of the materials is important to yield a photonic-crystal optical functional device.

Controlling the refractive indices of the materials also plays an important role in other devices using photonic crystals than such optical functional devices. To achieve desired properties of the photonic crystal device, individual microstructures constituting the crystal must be fabricated with a very high precision and with a very small allowable limit of error. As a possible solution to these problems, the photonic crystal itself is to have a tunable property and is controlled or tuned to have a desired property after its fabrication.

Controlling the refractive index is substantially important in photonic crystals and is essential when they are applied to optical functional devices. The photonic crystals generally comprise silicon (Si), gallium arsenide (GaAs), and another semiconductor as a high refractive index medium and the air or SiO₂ as a low refractive index medium. The refractive index may be changed by, for example, applying an electric field to the semiconductor. However, the device must have structurally complex electrodes to effectively apply the electric field. In addition, a very high voltage must be applied to yield such changes in refractive index as to activate as an optical functional device.

The refractive index may be changed and controlled by using the thermooptic effect of a semiconductor as disclosed in the examples of the aforementioned Japanese Patent Application Laid-Open No. 2000-121987. However, even according to this technique, the temperature must be significantly changed to yield effective changes in refractive index in the disclosed device form, thus being less practical.

Accordingly, a demand has been made on a technique to yield significant changes in refractive index with a relatively simple configuration.

### SUMMARY OF THE INVENTION

Accordingly, an object of the present invention is to yield a photonic crystal that can yield sufficiently large changes in refractive index with a relatively simple configuration and to provide an optical functional device using the same and a fabrication process of the optical functional device.

To achieve the above object, an optical functional device according to the present invention includes a photonic crystal containing at least one polymer as a material. The optical functional device can control the band structure of the photonic crystal by changing the temperature of the polymer to thereby change the refractive index of the photonic crystal.

Specifically, the present invention provides, in one aspect, an optical functional device including two or more materials having different refractive indices, the two or more materials being structurally periodically arrayed, in which at least one of the two or more materials is a polymer, and the temperature of at least a part of the polymer can be changed.

The present invention provides, in another aspect, an optical functional device including a photonic crystal, in which the photonic crystal includes at least one polymer, and the temperature of the polymer is changed to thereby control the refractive index of the photonic crystal.

The polymer is preferably one that increases in plasticity upon heating.

The two or more materials being structurally periodically arrayed may be stacking thin films including two or more different thin films, and at least one of the thin films includes a polymer.

The two or more materials may be two-dimensionally periodically arrayed and include a first dielectric material constituting columns, the columns being periodically arrayed and extending in a direction substantially perpendicular to a substrate; and a second dielectric material bridging a gap among the columns of the first dielectric material, and the first dielectric material may be a polymer.

Alternatively, the two or more materials may be two-dimensionally periodically arrayed and include a first dielectric material constituting columns, the columns being periodically arrayed and extending in a direction substantially perpendicular to a substrate; and a second dielectric material bridging a gap among the columns of the first dielectric material, and the second dielectric material may be a polymer.

The optical functional device may further comprise a thin-film heater for changing the temperature of the polymer.

The polymer is preferably a fluorinated polyimide.

The two or more materials structurally periodically arrayed may have a point defect waveguide and/or a line defect waveguide.

In addition and advantageously, the present invention provides a process for fabricating an optical functional device, including the steps of:

forming plural holes at regular intervals on a substrate;

forming a metal thin film on the substrate exclusive of the plural holes; and

charging a polymer precursor into the plural holes.

Further objects, features and advantages of the present invention will become apparent from the following description of the preferred embodiments with reference to the attached drawings.

### BRIEF DESCRIPTION OF THE DRAWINGS

FIG. 1 is a schematic diagram illustrating the present invention;

FIG. 2 illustrates a two-dimensional photonic crystal;

FIG. 3 is a diagram of a photonic band corresponding to the two-dimensional photonic crystal shown in FIG. 2;

FIG. 4 is a graph showing the temperature dependence of the refractive index of a polyimide;

FIG. 5 is a schematic diagram of an optical functional device according to First Embodiment of the present invention;

FIG. 6 shows a photonic crystal unit of the device shown in FIG. 5;

FIG. 7 is a sectional view along with the lines P-P′ of FIG. 5;

FIGS. 8a through 8g show process steps for the fabrication of an optical functional device according to the present invention;

FIG. 9 is a diagram showing a requirement in charging a polymer into a fine hole;

FIG. 10 is a dispersion curve with respect to wavelengths in a dispersion compensator according to First Embodiment;

FIG. 11 is a graph showing the relation between the refractive index change and the resonant wavelengths of microcavities;

FIG. 12 is a graph showing the relation between the temperature change and the dispersion change in the dispersion compensator according to First Embodiment;

FIG. 13 is a schematic diagram of an optical functional device according to Second Embodiment of the present invention;

FIGS. 14a and 14b are diagrams illustrating the operation of the device of Second Embodiment as a tunable wavelength filter;

FIG. 15 is a graph showing the relation between the temperature and the selected wavelength in the tunable wavelength filter according to Second Embodiment;

FIG. 16 is a schematic diagram of an optical functional device according to Third Embodiment of the present invention, in which the temperature of the device is changed by using laser light;

FIG. 17 is a schematic diagram of an optical functional device having a Si-column lattice with air cladding as a two-dimensional photonic crystal;

FIG. 18 is a schematic diagram of an example of an optical module having the tunable dispersion compensator according to First Embodiment;

FIG. 19 is a schematic diagram of another example of an optical module using the tunable dispersion compensator according to First Embodiment;

FIG. 20 is a block diagram of a wavelength division multiplexing system using the tunable dispersion compensator according to First Embodiment; and

FIG. 21 is a block diagram of a wavelength division multiplexing system using the tunable dispersion compensator and the tunable wavelength filter according to First and Second Embodiments, respectively.

### DETAILED DESCRIPTION OF THE PREFERRED EMBODIMENTS

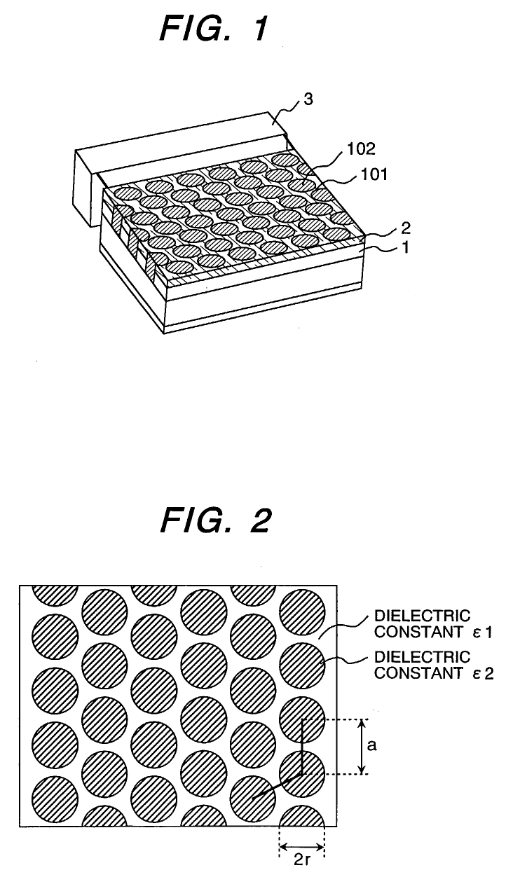

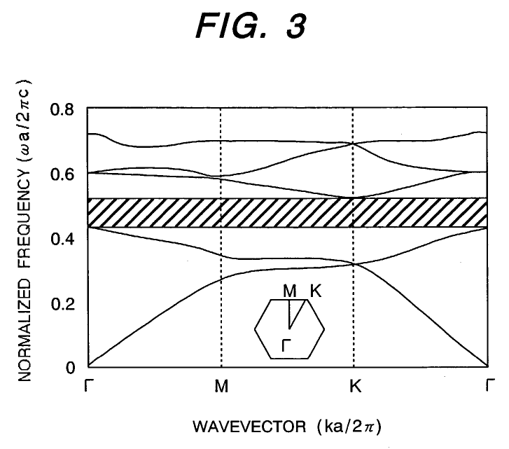

The optical functional device of the present invention can control the band structure of the photonic crystal by changing the temperature of the polymer to thereby change the refractive index of the photonic crystal. For example, with reference to the schematic diagram of FIG. 1, a polymer 102 is charged into holes 101 formed in a two-dimensional photonic crystal 1 comprising a semiconductor and the air. The charged polymer 102 is heated by a thin-film heater 2. The temperature is controlled by a temperature controller 3. In this example, the polymer is heated. To cool the polymer, for example, a Peltier device is used.

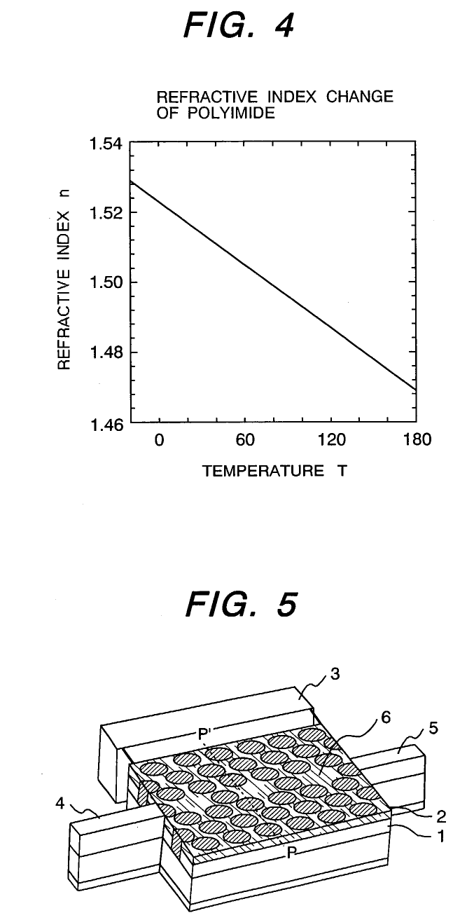

Polymer materials generally change in refractive index with temperature. Such polymer materials include, for example, polymethyl methacrylate (PMMA) polycarbonates (PCs) and polyimides. Among them, polyimides have a glass transition temperature of equal to or higher than 300° C. and can thereby yield large changes in refractive index upon heating. FIG. 4 shows the temperature dependence of refractive index of a polyimide. The magnitude of refractive index changes with temperature is expressed by a thermooptic coefficient dn/dT. In FIG. 4, the thermooptic coefficient is expressed by the slope of the graph. Such a polyimide has a thermooptic coefficient of about −3×10⁻⁴ K⁻¹, and the absolute value thereof is larger than that of silica (SiO₂) by an order of magnitude, although the silica has a nearly equivalent refractive index to the polyimide. In the polyimide, the refractive index is opposite in sign to that in Si and other semiconductors. When these two materials are heated together, the polyimide decreases in refractive index but Si increases. Accordingly, a relatively small temperature change can lead to an increased difference in refractive index between the two materials. Such polyimides for use in the present invention include, but are not limited to, a polyimide represented by the following chemical formula:

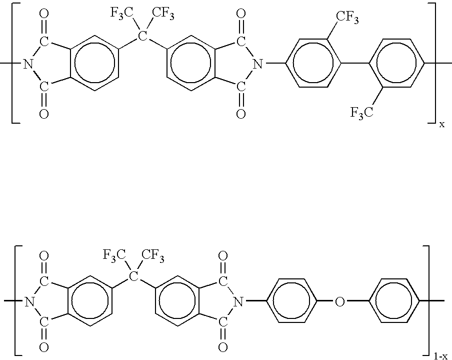

By using such a polymer as a material, the optical functional device can be easily fabricated. A thin film of the polymer can be formed by applying a polymer precursor to a substrate and baking the applied polymer precursor. Accordingly, a photonic crystal containing the polymer can be easily fabricated by applying the polymer precursor to a pretreated substrate and baking the applied polymer precursor.

Preferred embodiments of the present invention will be illustrated below with reference to the attached drawings.

First Embodiment

FIG. 5 is a schematic diagram of a tunable dispersion compensator according to an embodiment of the present invention. The tunable dispersion compensator is a device using optical transmission properties of a coupled cavity waveguide to compensate the deterioration of pulse waveform due to wavelength dispersion of a transmission medium in an optical pulse transmission path. The device of the present embodiment comprises a silicon on insulator (SOI) substrate with a Si/SiO₂/Si stacking structure, and a photonic crystal 1 including a polymer, a thin-film heater 2, a temperature controller 3 to supply power to the heater 2, and input/output waveguides 4 and 5 respectively arranged on the substrate.

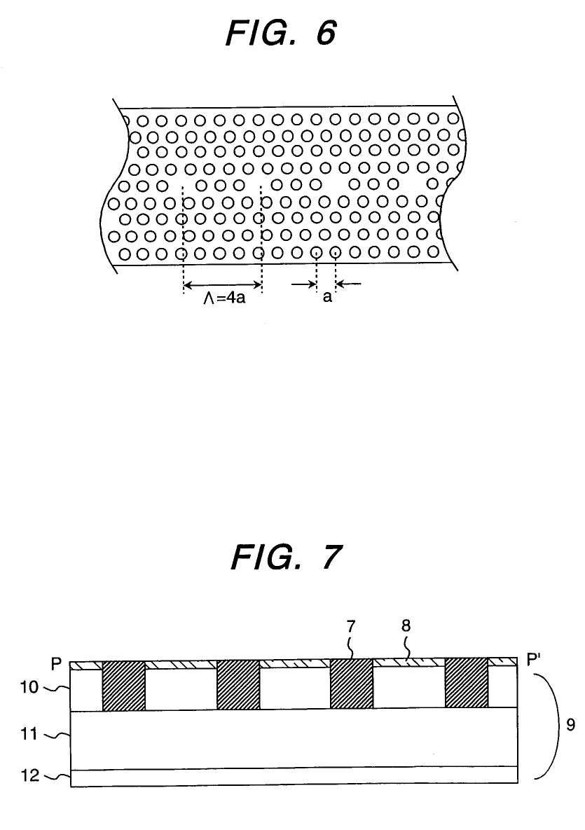

FIG. 6 illustrates the configuration of the photonic crystal unit of the device. The two-dimensional photonic crystal shown in FIG. 6 has a columnar triangular lattice array as in the two-dimensional photonic crystal in FIG. 2. The triangular lattice has a lattice constant a of 0.600 μm and a radius of the column r of 0.27 μm. The photonic crystal has a row of point defects as a waveguide, i.e., a coupled defect waveguide. Such point defects are generally formed by changing the size of the holes or the refractive index. In this device, point defects 6 are formed by setting the size of the holes at zero, i.e., a part of the holes is not opened. The row of defects has a period of defect Λ in a Γ-M direction four times larger than the lattice constant. The row of defects constitutes a coupled cavity waveguide and serves as a dispersion compensating waveguide. The photonic crystal unit has a length of 10 mm in a longitudinal direction.

FIG. 7 is a sectional view along with the lines P-P′ of FIG. 5, in which a SiO₂ layer 11 and a Si layer 10 are arranged on a Si substrate 12 to form a SOI structure 9. A Cr layer 8 having a thickness of 0.5 μm to serve as a thin-film heater is arranged on the Si layer 10. Holes are opened at set regular intervals on the Si layer 10 and the Cr layer 8 and are filled with a polyimide 7 to constitute the photonic crystal.

Example of the polyimide 7 are fluorinated polyimides represented by the chemical formula and prepared from 2,2′-bis(3,4-dicarboxyphenyl)hexafluoropropane dianhydride (6FDA) with 2,2-bis(trifluoromethyl)-4,4′-diaminodiphenyl (TFDB) and/or 4,4′-oxydianiline (ODA). The fluorinated polyimides can change in refractive index by changing the ratio of TFDB to ODA. In the present embodiment, a fluorinated polyimide comprising 6FDA and TFDB alone, i.e. x=1, is used. The SiO₂ layer 11 and the Si layer 10 have a thickness of 3 μm and 0.5 μm, respectively.

Polymers expand and have an increased volume upon heating and thereby have a decreased refractive index. The polymer in such a structure must be allowed to expand freely. When round holes are filled with the polymer and the top of the filled polymer is completely covered with an electrode, the polymer cannot expand and thereby fails to yield sufficient refractive index changes. The thin-film heater therefore must not completely cover the top of the polymer as in the present embodiment.

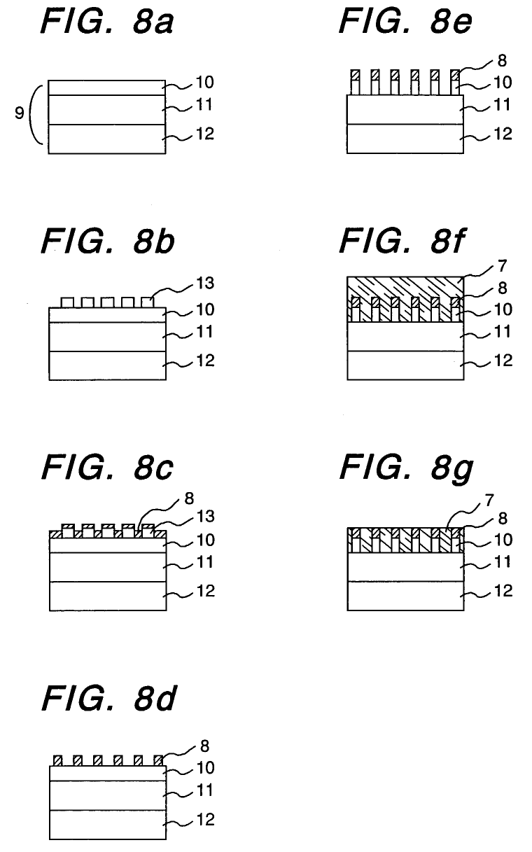

A fabrication process of a photonic crystal defect waveguide will be illustrated with reference to FIGS. 8a through 8g.

With reference to FIG. 8a, a SOT substrate 9 is used as a substrate. The SOI substrate 9 comprises an underlayer Si layer 12, a SiO₂ layer 11 having a thickness of 3 μm, and a Si layer 10 having a thickness of 0.5 μm.

Initially, with reference to FIG. 8b, a resist pattern 13 having a thickness of 1 μm is formed by electron beam lithography. With reference to FIG. 8c, a Cr layer 8 having a thickness of 0.5 μm is formed by sputtering. The resist pattern 13 is then removed and the Cr layer on the resist is stripped with the resist. The Cr layer directly disposed on the Si layer 10 remains as shown in FIG. 8d. Thus, the Cr film with a reverse image of the resist pattern is transferred.

Thus, the patterned Cr layer 8 is formed by a “lift off” process. The Si layer 10 is etched by reactive ion etching using the patterned Cr layer 8 as a mask as shown in FIG. 8e.

Next, a solution of a polyamic acid as a polyimide precursor, N,N-dimethylacetamide, is applied by spin coating. In this procedure, the film is preferably formed to a thickness larger than a desired thickness and is then etched to the desired thickness, since the thickness of the resulting polyimide film is difficult to control by only controlling the amount of the solution.

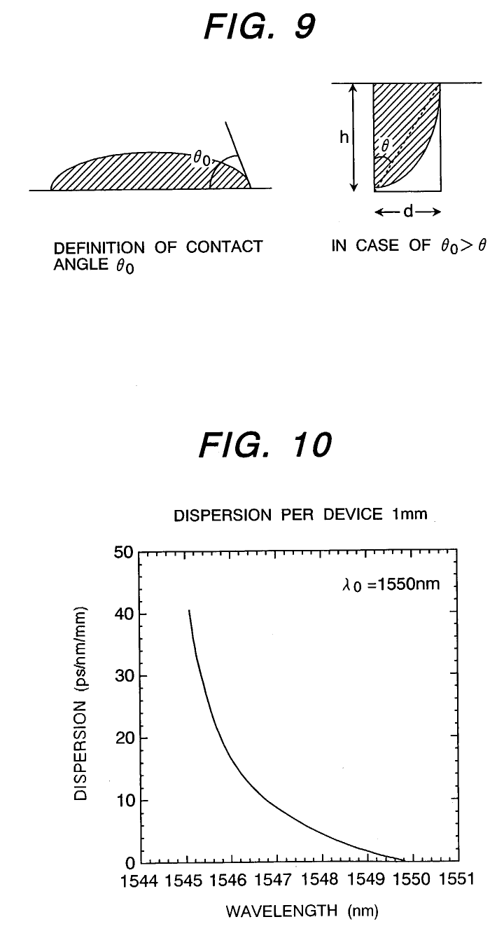

In this procedure, the material must be charged into fine holes leaving no space. However, if the material has an excessively high viscosity, it is charged into the holes with space at the bottom due to buildup from the wall as shown in FIG. 9. To avoid this problem, the viscosity of the material solution is adjusted so that the contact angle θ0 which the material forms with the wall of the hole is smaller than the angle θ tan⁻¹ (d/h) which the diameter d of the hole forms with the height h of the hole.

Air bubbles in the holes are then removed by evacuation after charging the polymer precursor. The polymer precursor is then heated for imidation and thereby yields a polyimide layer 7 shown in FIG. 8F. Ultimately, the excess polyimide is removed by reactive ion etching using oxygen to yield a device including the charged polyimide as shown in FIG. 8G. The Cr film 8 used as a mask in etching of the Si layer 10 is not stripped and is used as a thin-film heater.

Operations to compensate the dispersion of the device will be illustrated below. The dispersion D of the coupled cavity waveguide is determined by following Equation (1):

D=d/dλ(1/Vg) (1)

wherein Vg=dω/dk=ΛΩ(κ²−(ω/Ω−1)²)^{1/2}, where Λ is the distance between cavities; Ω is the resonant angular frequency of each cavity (point defect); ω is the angular frequency of light transmitting in the coupled cavity waveguide; and κ is a constant relating to the intensity of the interaction between the cavities and is determined by, for example, the structure of the cavities and the distance between cavities.

Λ, Ω, and κ are constants depending on the structure, and D is a function with respect to ω. ω corresponds to the wavelength of the light, and the dispersion D is expressed as a function with respect to the wavelength when the structure of the waveguide is determined. Λ is geometrically determined and is 4a in the structure shown in FIG. 5. Ω is 0.38964×2πc/a, corresponding to 1550 nm in terms of wavelength, as determined by calculation according to a plane wave expansion method. κ is determined by fitting a measured group velocity to an equation and is found to be −0.004.

The determined dispersion is shown in FIG. 10 with the ordinate showing the dispersion per 1-mm device and the abscissa showing the wavelength. For example, the device has a dispersion of about 20 ps/nm/mm with respect to light having a wavelength of 1546 nm.

The tuning operation of the dispersion will be described below. When the electrode 2 is energized to heat the polymer and Si, Si serving as a high refractive index medium has an increased refractive index, and the polyimide serving as a low refractive index medium has a decreased refractive index. Thus, the refractive index difference between the two media increases by heating. Consequently, the structure of the photonic crystal changes to thereby change the resonant frequency of the point defect microcavities, i.e., Ω in Equation (1)

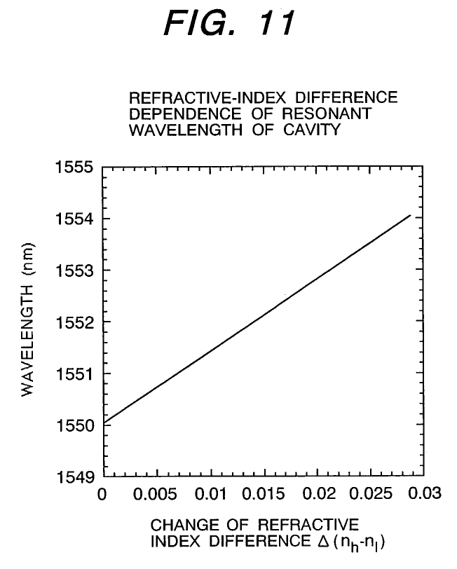

FIG. 11 shows changes in the resonant frequency Ω in terms of wavelength with a varying refractive index difference. In the abscissa, nₕ and nₗ are refractive indices of the high refractive index medium and the low refractive index medium, respectively. The resonant wavelength change leads to changes in the dispersion curve. FIG. 10 is a graph at a resonant wavelength of 1550 nm. When the resonant wavelength increases, the curve translates into a longer wavelength direction.

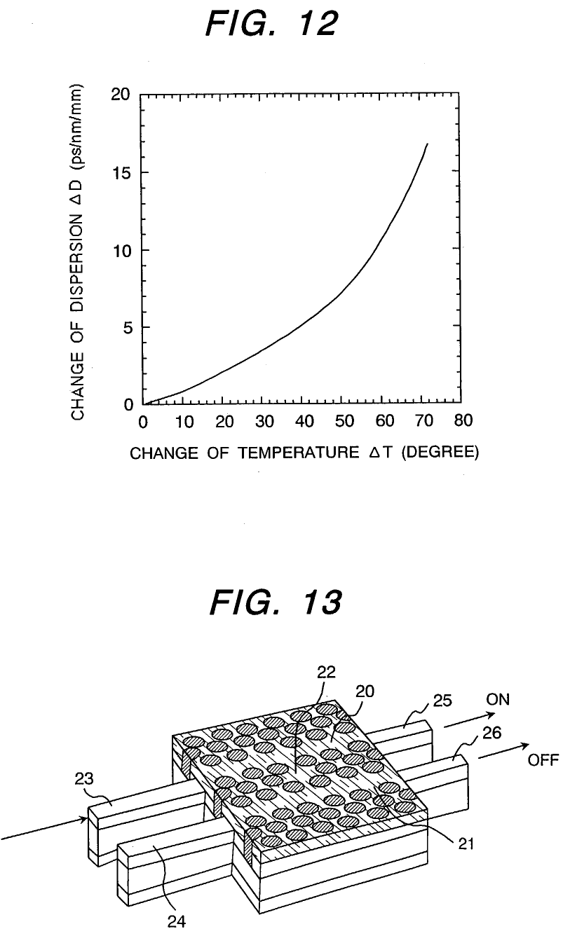

Accordingly, the dispersion with respect to light of the same wavelength increases with an increasing resonant wavelength. FIG. 12 is a graph of a dispersion curve with temperature changes in light with a wavelength of 1550 nm in consideration of the thermooptic coefficient of the polyimide and Si. The graph indicates that a desired dispersion can be obtained by controlling the temperature. For example, a dispersion of about 15 ps/nm per 1-mm device is obtained by setting ΔT at 70 degrees. The device has an overall length of 10 mm and has a tunable dispersion range of about 150 ps/nm. Thus, the device can achieve tunable dispersion with a relatively small temperature change and with a relatively low power consumption.

The present invention has been described by taking a tunable dispersion compensator as an example. Likewise, the present invention can also be applied to a tunable optical time-delay device using properties of light transmitting a coupled cavity waveguide. The resulting device is of high quality and compact in size.

Second Embodiment

FIG. 13 is a schematic diagram of a space optical switch using a two-dimensional photonic crystal line defect waveguide and microcavities in combination according to another embodiment of the present invention. The device comprises a polymer-embedded photonic crystal 1, a Cr thin-film heater 6, and input/output waveguides 23, 24, 25, and 26. The two-dimentional photonic crystal used herein has the same structure as in the device according to First Embodiment.

In the present embodiment, first and second line defects 20 and 21 are arranged as waveguides in the photonic crystal. The device lacks two rows of holes filled with the polymer in a Γ-M direction to thereby form the two line defect waveguides 20 and 21. In addition, a point defect 22 is arranged between the two line defect waveguides 20 and 21. The point defect 22 serves as a microcavity with respect to light of a specific wavelength and plays a role to transmit energy of light at the resonant wavelength of the microcavity from one waveguide to the other. The outermost Cr layer is connected to a power supply (not shown) and produces heat by energizing.

The operations of the device will be illustrated. In the device, a light signal enters at a first input port 23 or a second input port 24 and is taken out from a first output port 25 or a second output port 26. The temperature of the device is controlled with the thin-film heater to thereby decide from which port the light signal is output.

The resonant wavelength of the point defect 22 is 1550 nm without heating, as described in First Embodiment. Accordingly, light of 1550 nm entered at the first input port 2 and transmitting in the first line defect waveguide 20 produces resonance with the point defect 22, thus the energy of the light moves to the second line defect waveguide 21, and the light exits from the second output port 26.

When the heater is energized to raise the temperature, the resonant wavelength of the point defect 22 shifts, and the light of 1550 nm moves straight forward and exits from the first output port 25. Thus, the device can produce an output from a desired output port of the two output ports 25 and 26.

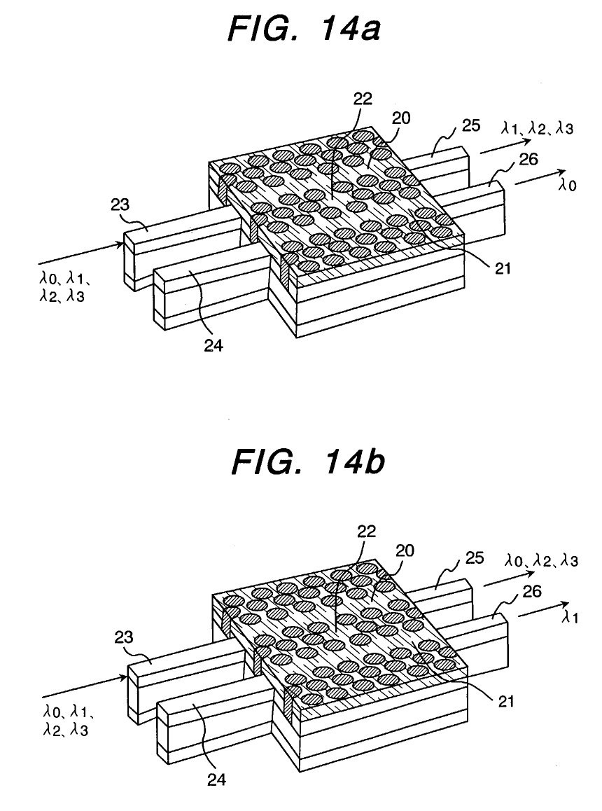

The device according to the present embodiment can be used as a tunable wavelength filter in a wavelength division multiplexing system. The operations of the tunable wavelength filter will be illustrated with reference to FIGS. 14a and 14b. In the device, multiplexed light enters at the first input port 23, light of an optional wavelength among the multiplexed light is output from the second output port 26, and light of the other wavelengths is output from the first output port 25.

In an example in FIG. 14a, light with four wavelengths, λ0, λ1, λ2, and λ3 is multiplexed and enters at the first input port 23. When the resonant wavelength of the point defect 22 is tuned at λ0 at room temperature, light with wavelengths of λ1, λ2, and λ3 among light entered at the first input port 23 moves straight forward and exits from the first output port 25. The light with a wavelength of λ0, i.e., the resonant wavelength of the point defect 22 moves via the point defect 22 to the second line defect waveguide 21 and exits from the second output port 26.

By energizing the Cr thin-film heater and thereby heating the photonic crystal, the resonant wavelength of the point defect cavity 22 changes, and thus the wavelength of light output from the second output port 26 changes. For example, the light with a wavelength λ1 is output from the second output port 26 in FIG. 14B.

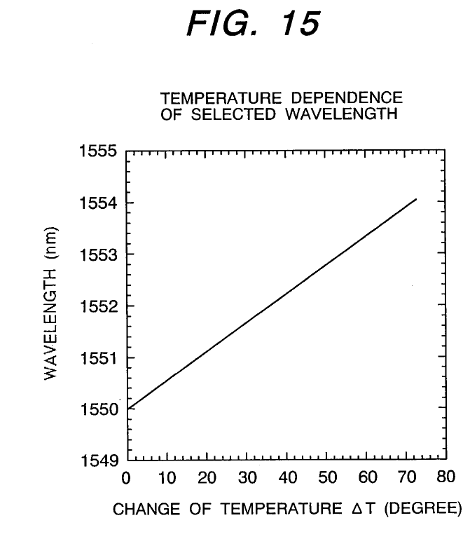

FIG. 15 is a graph showing the relation between the temperature of the polymer and Si and the output wavelength from the second output port 26. The graph demonstrates that light with a wavelength of 1550 nm is output at room temperature (ΔT=0), and light with a wavelength of 1553 nm is output at ΔT of 50 degrees. This type of tunable wavelength filter can be used as an add/drop functional device in wavelength division multiplexing systems.

The present invention has been described by taking an optical switch and a tunable wavelength filter as an example. A device having a similar configuration according to the present invention can also be used as an optical amplitude modulator.

Third Embodiment

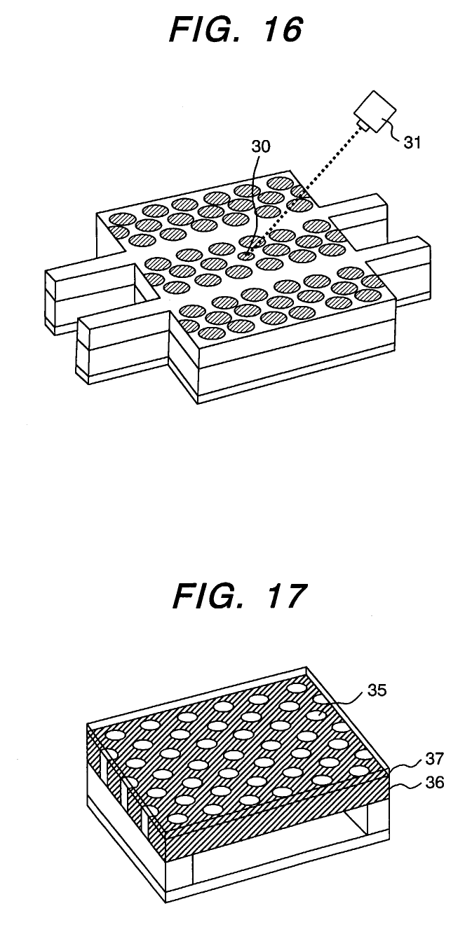

FIG. 16 is a schematic diagram of an optical functional device according to yet another embodiment of the present invention. The device shown in FIG. 16 is a tunable wavelength filter as in Second Embodiment. The device according to the present embodiment further comprises a laser unit 31 as a heating means. By using the laser, the device can be heated locally.

With reference to FIG. 16, the device has a hole having a smaller diameter to thereby yield a point defect 30. Thus, the point defect 30 is also filled with a polymer. The polymer in the point defect 30 is heated by applying light with a wavelength different from the signal light using the laser unit 31. The heated polymer changes in refractive index, and thus the wavelength of light to be output changes as in Second Embodiment.

In First and Second Embodiments, the present invention has been described by taking a photonic crystal structurally having a two-dimensional hole triangular lattice comprising Si as a host material and being arranged on a SOI substrate as an example. The structures of such photonic crystals are not specifically limited and include various structures of one-dimensional, two-dimensional, and three-dimensional structures. In any case, similar advantages as above can be obtained.

For example, FIG. 17 is a schematic diagram of an optical functional device comprising a two-dimensional photonic crystal using a Si-column lattice with air cladding. The device has a photonic crystal comprising Si columns 35 and a polymer 36 surrounding the Si columns 35. The device further comprises a thin-film heater 37 on its top and an air cladding at its bottom.

In general, a photonic crystal comprising the air and semiconductor columns cannot have an air cladding structure. However, the device according to the present embodiment comprises semiconductor columns supported by the polymer and can thereby have an air cladding structure. In addition to the device of the present embodiment, such devices comprising an embedded polymer can be tougher than those comprising the air and a semiconductor.

In addition, devices comprising a one-dimensional photonic crystal having stacking polymer thin films and thin films of another dielectric substance can have equivalent functions to those described in First and Second Embodiments.

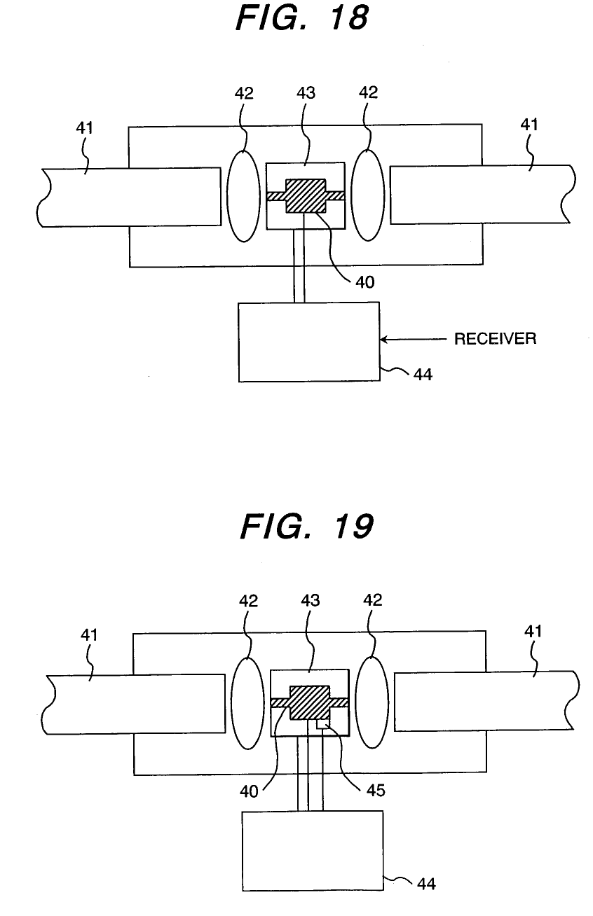

FIGS. 18 and 19 illustrate optical modules using the tunable dispersion compensator according to First Embodiment.

The optical module shown in FIG. 18 comprises a tunable dispersion compensator 40 according to First Embodiment, an optical fiber 41 and lenses 42, and a Peltier device 43 on the optical axis of the tunable dispersion compensator 40, as well as a temperature controller 44. In this module, a receiver receives an optical signal after transmitting the module and outputs a control signal. The temperature controller 44 receives the control signal and controls a current applied to a heater of the tunable dispersion compensator 40 for heating or a current applied to the Peltier device 43 for cooling to thereby control the dispersion at a desired level.

FIG. 19 illustrates another module according to the present embodiment. The module further comprises a temperature sensor 45 to determine the temperature of the device in addition to the components of the module shown in FIG. 18. The temperature controller 44 herein does not receive an external control signal but receives information on the measured temperature from the temperature sensor 45 to thereby control the temperature of the device at a desired level.

Next, an optical transmission system using the tunable dispersion compensator according to the present invention will be illustrated.

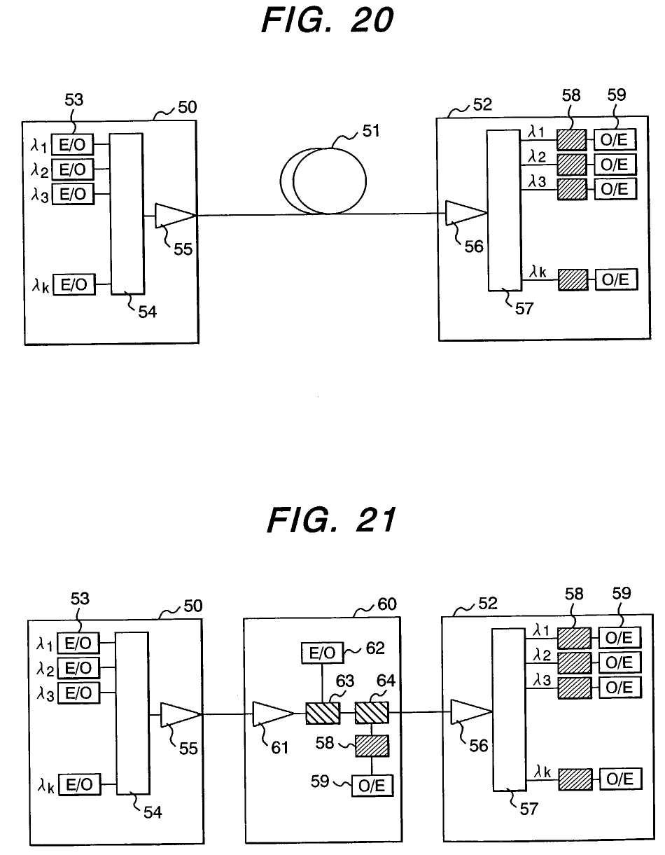

FIG. 20 illustrates a wavelength division multiplexing system of 40 Gbps/channel using the tunable dispersion compensator according to First Embodiment. The system comprises a transmitter 50, an optical fiber transmission path 51, and a receiver 52.

The transmitter 50 comprises electro-optic converters (E/O) 53 for each wavelength (channel), a multiplexer 54, and a transmitter amplifier 55. These components can be conventional components. Light with wavelengths around 1.55 μm is used. The optical fiber transmission path 51 is a dispersion compensating fiber with a transmission distance of 80 km.

The receiver 52 comprises an optical receiver amplifier 56, a wavelength filter 57, tunable dispersion compensators 58 according to First Embodiment, and an opto-electric converter (O/E) 59. Multiplexed and transmitted optical pulses are divided in the wavelength filter 57 into individual wavelengths and undergo optimum compensation in the tunable dispersion compensators 58 in individual channels.

The dispersion compensating fiber 51 exhibits a dispersion less than or equal to several picoseconds per nm per km at wavelengths of 1.53 to 1.6 μm. The dispersion is about ±200 ps/nm at the maximum at a transmission distance of 80 km, but the dispersion varies depending on the channel (wavelength). Each of the tunable dispersion compensators 58 has a tunable dispersion of ±150 ps/nm and can thereby nearly completely compensate the dispersion in every channel.

Next, an optical transmission system using the tunable dispersion compensator and the tunable wavelength filter according to First and Second Embodiments, respectively, will be illustrated.

FIG. 21 is a block diagram of the optical transmission system. The system comprises a transmitter 50, an optical fiber transmission path (not shown), a line amplifier 60, and a receiver 52. The transmitter 50 and the receiver 52 have the same configurations as in the system shown in FIG. 20. The line amplifier 60 at least comprises an optical amplifier 61, a tunable add multiplexer 63, an electro-optic converter 62, a tunable channel-drop filter 64, a tunable dispersion compensator 58, and an opto-electric converter 59. The line amplifier in the system is capable of applying an optical signal with an optional wavelength to the transmission path and is capable of receiving an optical signal with an optional wavelength.

The electro-optic converter 62 preferably has a tunable-wavelength laser to thereby produce an optical signal with a desired wavelength. The produced optical signal is multiplexed in the tunable add multiplexer 63 having the same configuration as in the tunable wavelength filter described in Second Embodiment. The multiplexing operation is in reverse order to that in the device described in Second Embodiment.

A system comprising the tunable channel-drop filter 64, the tunable dispersion compensator 58, and the opto-electric converter 59 serves to select a signal of a specific wavelength and to convert the same into an electric signal. The multiplexed optical signal is separated or filtered in the tunable channel-drop filter 64 according to the process described in the device of Second Embodiment, undergoes compensation in waveform distortion by the tunable dispersion compensator 58 and is then received.

The line amplifier having such add/drop functions can increase the flexibility of optical communication systems.

The present invention includes the following configurations.

(1) An optical functional device comprising two or more materials having different refractive indices, the two or more materials being structurally periodically arrayed, in which at least one of the two or more materials is a polymer, and the device comprises a means to change the temperature of a part and/or all of the polymer.

(2) The optical functional device according to (1), in which the polymer is charged in an open system so as to allow the polymer to change in volume with a varying temperature.

(3) The optical functional device according to (1), in which the polymer increases in plasticity upon heating.

(4) The optical functional device according to (1), in which the polymer is charged in such a less amount as to form an ideal periodic structure at operating temperature even after the polymer expands upon heating.

(5) The optical functional device according to (1), in which the two or more materials being structurally periodically arrayed are stacking thin films comprising two or more different thin films, and at least one of the thin films comprises a polymer.

(6) The optical functional device according to (1), in which the two or more materials are two-dimentional periodically arrayed and comprise a first dielectric material constituting columns, the columns being arrayed at regular intervals and extending in a direction substantially perpendicular to a substrate; and a second dielectric material bridging a gap among the columns of the first dielectric material, and the first dielectric material is a polymer.

(7) The optical functional device according to (1), in which the two or more materials are two-dimensionally periodically arrayed and comprise a first dielectric material constituting columns, the columns being arrayed at regular intervals and extending in a direction substantially perpendicular to a substrate; and a second dielectric material bridging a gap among the columns of the first dielectric material, and the second dielectric material is a polymer.

(8) The optical functional device according to (6), in which the diameter d, the height h of the polymer column, and the contact angle θ0 which a precursor of the polymer forms with the wall of the column satisfy the following condition: θ0>tan⁻¹ (d/h).

(9) The optical functional device according to (1), in which the means for changing the temperature is a thin-film heater.

(10) The optical functional device according to (9), in which the polymer is not covered with the thin-film heater.

(11) The optical functional device according to (1), in which the means for changing the temperature is laser.

(12) The optical functional device according to (1), in which the means for changing the temperature is a Peltier device.

(13) The optical functional device according to (1), in which the polymer is a fluorinated polyimide represented by following chemical formula:

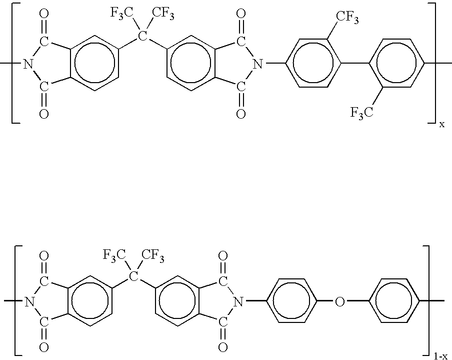

(14) The optical functional device according to (9), in which the thin-film heater is a metal thin film used as an etching mask in its fabrication.

(15) The optical functional device according to (1), which is a tunable dispersion compensator capable of compensating a dispersion in a transmission medium in an optical pulse transmission path, in which the dispersion is controlled by changing the temperature.

(16) The optical functional device according to (1), which is an optical switch capable of spatially switching optical pulse transmission paths, in which the temperature is controlled to thereby switch the optical pulse transmission paths.

(17) The optical functional device according to (1), which is a tunable wavelength filter capable of selecting an optical pulse with a specific wavelength from multiplexed optical pulses and spatially separating the same, in which the temperature is controlled to thereby select the optical pulse to be spatially separated.

(18) The optical functional device according to (1), which is a tunable optical time-delay device capable of delaying optical pulses, in which the temperature is controlled to thereby control the delay time.

(19) The optical functional device according to (1), which is an optical amplitude modulator capable of changing the amplitude of optical pulses, in which the temperature is controlled to thereby change the amplitude.

(20) A process for fabricating a periodic structure of the optical functional device according to (1), comprising the steps of applying a polymer precursor, heating and polymerizing the applied polymer precursor to form a polymer layer, in which the process further comprises a step of reducing the pressure between the step of applying the polymer precursor and the step of heating the same.

(21) A process for fabricating a periodic structure of the optical functional device according to (6) or (7), comprising the steps of applying a polymer precursor, heating and polymerizing the applied polymer precursor to form a polymer layer, in which a polymer layer having a thickness larger than a desired thickness is formed, and the formed polymer layer is etched to the desired thickness by dry etching.

(22) An optical module having the optical functional device according to (1), which comprises a temperature controller and is capable of holding the temperature of the device at a desired level regardless of the ambient temperature.

(23) An optical transmission system using the optical functional device according to any one of (1) to (18) in at least one of a transmitter, a line amplifier and a receiver.

As thus described above, the present invention can provide optical functional devices using an ultracompact and high-performance photonic crystal. The invention can also provide optical transmission systems at low cost with high reliability.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An optical functional device comprising two or more materials having different refractive indices, the two or more materials being structurally periodically arrayed,
wherein at least one of the two or more materials is a polymer, and
wherein the temperature of at least a part of the polymer can be changed.

2. An optical functional device comprising a photonic crystal,
wherein the photonic crystal comprises at least one polymer, and
wherein the temperature of the polymer is changed to thereby control the refractive index of the photonic crystal.

3. The optical functional device according to one of claims 1 and 2, wherein the polymer increases in plasticity upon heating.

4. The optical functional device according to claim 1, wherein the two or more materials being structurally periodically arrayed are stacking thin films comprising two or more different thin films, and
wherein at least one of the thin films comprises a polymer.

5. The optical functional device according to claim 1, wherein the two or more materials are two-dimensionally periodically arrayed and comprise:
a first dielectric material constituting columns, the columns being periodically arrayed and extending in a direction substantially perpendicular to a substrate; and
a second dielectric material bridging a gap among the columns of the first dielectric material, and
wherein the first dielectric material is a polymer.

6. The optical functional device according to claim 1, wherein the two or more materials are two-dimensionally periodically arrayed and comprise:
a first dielectric material constituting columns, the columns being periodically arrayed and extending in a direction substantially perpendicular to a substrate; and
a second dielectric material bridging a gap among the columns of the first dielectric material, and
wherein the second dielectric material is a polymer.

7. The optical functional device according to one of claims 1 and 2, further comprising a thin-film heater for changing the temperature of the polymer.

8. The optical functional device according to one of claims 1 and 2, wherein the polymer is a fluorinated polyimide.

9. The optical functional device according to claim 1, wherein the two or more materials structurally periodically arrayed have a point defect waveguide and/or a line defect waveguide.

10. A process for fabricating an optical functional device, the process comprising the steps of:
forming plural holes at regular intervals on a substrate;
forming a metal thin film on the substrate exclusive of the plural holes; and
charging a polymer precursor into the plural holes.
